(19) United States
(12) Patent Application Publication
(10) Pub. No.: US 2008/0003473 A1
(43) Pub. Date: Jan. 3, 2008

(54) MICRO FUEL CELL SYSTEM

(76) Inventors: Chun-Chin Tung, Chu Pei (TW); Yung-Lieh Chien, Chu Pei (TW)

Correspondence Address: G. LINK CO., LTD, 3550 BELL ROAD, MINOOKA, IL, 60447, US

(21) Appl. No.: 11/744,805

(22) Filed: May 4, 2007

(30) Foreign Application Priority Data
Jun. 30, 2006 (TW) 095124035

(51) Int. Cl. H01M 8/04

(52) U.S. Cl. 429/26; 429/34

(57) ABSTRACT

The present invention relates to a micro fuel cell system comprising a fuel cell power-generating member that undergoes electrochemical reaction with fuel and outputs power; an electrical transmission mechanism to provide electrical signal transmission and power transmission in the micro fuel cell system; a fuel circulation module for storing and transporting the fuel or residual solution from the power-generating member after electrochemical reaction; a sensor module for detecting the physical properties of the fuel and outputting electrical signals corresponding to said physical properties; a computing module that selects and executes corresponding control procedure based on the corresponding electrical signals of physical properties; and a holder; wherein the power-generating member, the electrical transmission mechanism, the fuel circulation module, the sensor module and the computing module are arranged in the holder.

### FIELD OF THE INVENTION

The present invention relates to a micro fuel cell system, more particularly a kind of micro fuel cell system that integrates several fuel cell sensor devices on a PCB base.

### BACKGROUND OF THE INVENTION

Conventional fuel cells feature low pollution, easy recharge, high energy density, and high efficiency of energy conversion. Fuel cells are expected to become the mainstream battery application in the future, and will play a particularly important role in the design of portable electronic products. However current technology for compact and modularized design of fuel cells is inadequate.

In light of the drawbacks of conventional fuel cells, the inventor has been aiming to develop a micro fuel cell system in the hope to provide a compact and modularized fuel cell system.

### SUMMARY OF THE INVENTION

The primary object of the invention is to provide an integrated micro fuel cell system using a PCB base to reduce the size of fuel cell.

Another object of the invention is to provide micro sensor components for compact fuel cell.

A further object of the invention is to provide a modular fuel cell using PCB base for electrical connection and mechanical engagement.

Yet another object of the invention is to provide a fluid actuator for the circulation of fuel in the fuel cell.

To achieve the aforesaid objects, the present invention provides a micro fuel cell system, comprising a fuel cell power-generating member that undergoes electrochemical reaction with the fuel and outputs power; an electrical transmission mechanism for electrical signal transmission and power transmission in the micro fuel cell system; a fuel circulation module for storing and transporting the fuel or residual solution from the power-generating member after electrochemical reaction; a sensor module for detecting the physical properties of the fuel and outputting electrical signals corresponding to such physical properties; a computing module that selects and executes corresponding control procedure based on the electrical signal of the physical property; and a holder; wherein the power-generating member, the electrical transmission mechanism, the fuel circulation module, the sensor module, and the computing module are arranged in the holder.

The fuel circulation module further contains a fluid actuator to drive the circulation of fuel and residual solution in the fuel flow channel. The fluid actuator further comprises at least a one-way valve, a heating member and a cooling member; the one-way valve is a component for confining the one-way flow of fluid; the heating member is an area in the fuel flow channel formed in the vicinity of power-generating member, where fluid at the heating member is heated by the reaction heat generated during the electrochemical reaction of the power-generating member; and the cooling member is an area of the fuel circulation module near the fuel container, where fluid at the cooling member is cooled by the relatively low temperature in the surroundings. In addition, a heater may be provided to replace the action of heating member and heat part of the fuel circulation module to produce fuel flow therein.

The objects, features and effects of the invention are described in detail below with embodiments in reference to the accompanying drawings.

### BRIEF DESCRIPTION OF THE DRAWINGS

FIG. 1 is a diagram showing the relations of the components in the micro fuel cell system according to the invention;

FIG. 2 is a perspective view of the micro fuel cell system according to an embodiment of the invention;

FIG. 3 is a surface side view of the bipolar plate of the micro fuel cell system according to the invention;

FIG. 4 is a perspective view of the flow-field plate of the micro fuel cell system according to the invention;

FIG. 5 is another surface side view of the bipolar plate of the micro fuel cell system according to the invention;

FIG. 6 is a side cut-away view of the micro fuel cell system according to the invention;

FIG. 7 is a side view of the micro fuel cell system according to another embodiment of the invention;

FIG. 8 is a partial cut-away view of the fuel circulation module of the micro fuel cell system according to the invention; and

FIG. 9 is the perspective view of the flow-field plate of the micro fuel cell system according to yet another embodiment of the invention.

### DETAILED DESCRIPTION OF THE INVENTION

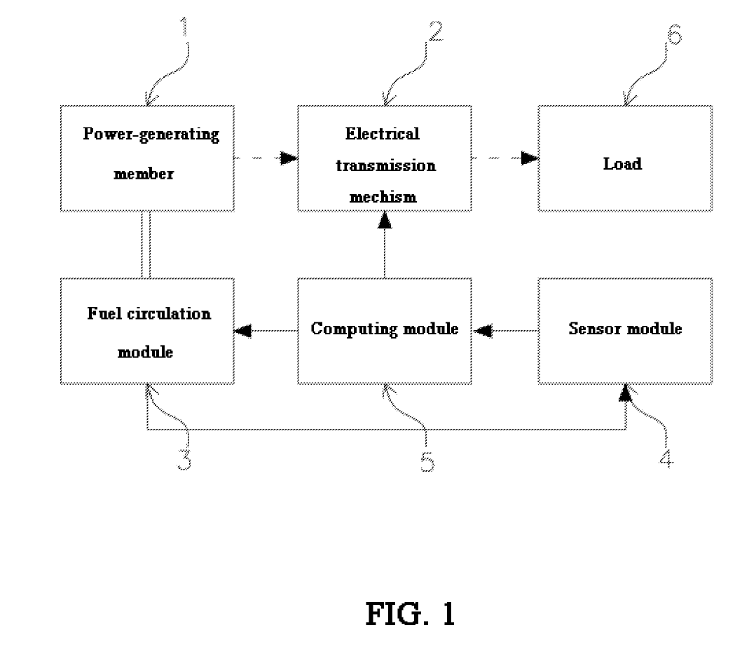

Referring to FIG. 1 which is a diagram showing the relations of the components in the micro fuel cell system, the micro fuel system comprises a power-generating member (1), an electrical transmission mechanism (2), a fuel circulation module (3), a sensor module (4), and a computing module (5) to provide fuel needed for the operation of power-generating member (1) and to monitor the physical properties of fuel, such as fuel concentration, temperature and quantity, and at the same time, control the power output of power-generating member (1) corresponding to a load (6). In the micro fuel cell system, the power-generating member (1) of fuel cell is an energy converter containing catalyst that can undergo electrochemical reaction with hydrogen-rich fuel and oxygen fuel simultaneously, and furthermore, convert chemical energy into electrical energy for output. For example, a direct methanol fuel cell can use Nafion membrane from DuPont as medium for energy conversion and undergo electrochemical reaction with methanol solution and oxygen to generate power for output. The electrical transmission mechanism (2) transmits power from the power-generating member (1) to an external load (6). The fuel circulation module (3) stores and transports fuel needed for the operation of power-generating member (1) or transports residual solution from the power-generating member (1) after the electrochemical reaction. The sensor module (4) detects fuel concentration, quantity or temperature, or other physical properties of the fuel in fuel cell, and outputting electrical signals corresponding to those physical properties. The computing module (5) can capture the feedback of electric signals from the sensor module (4), and based on which, execute corresponding control procedure.

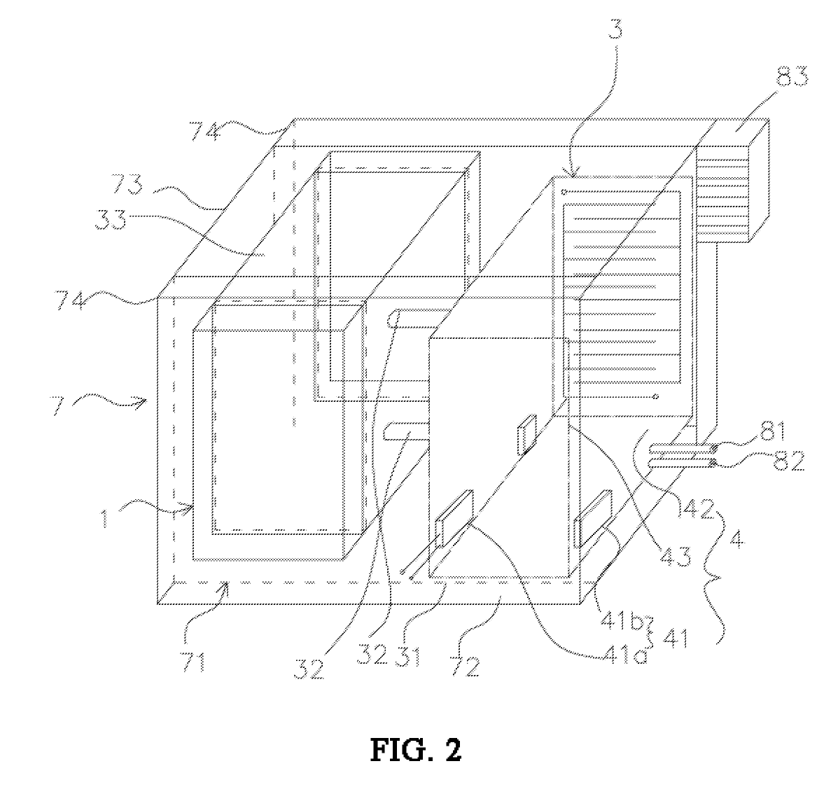

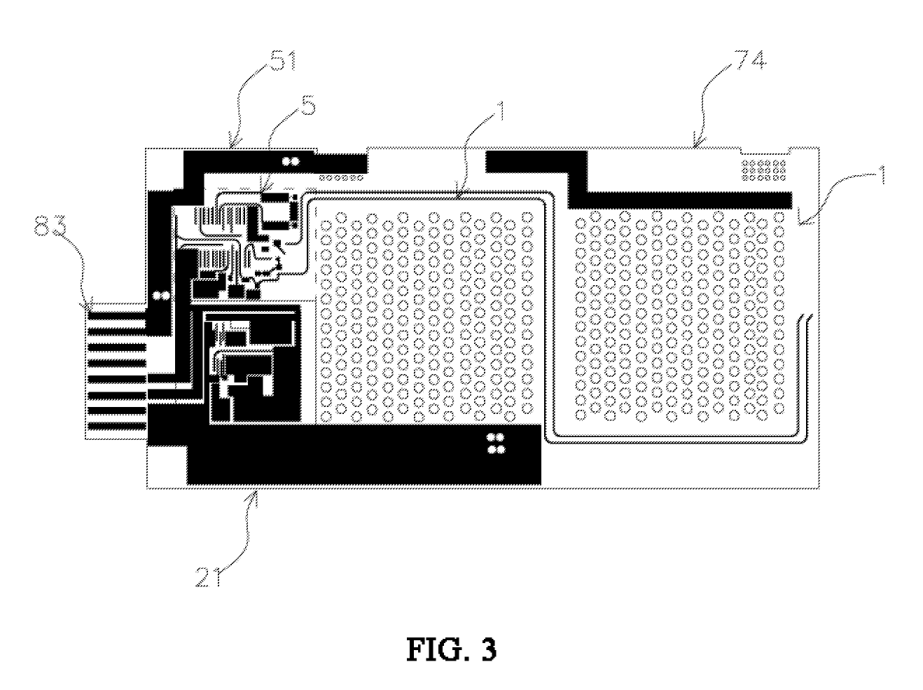

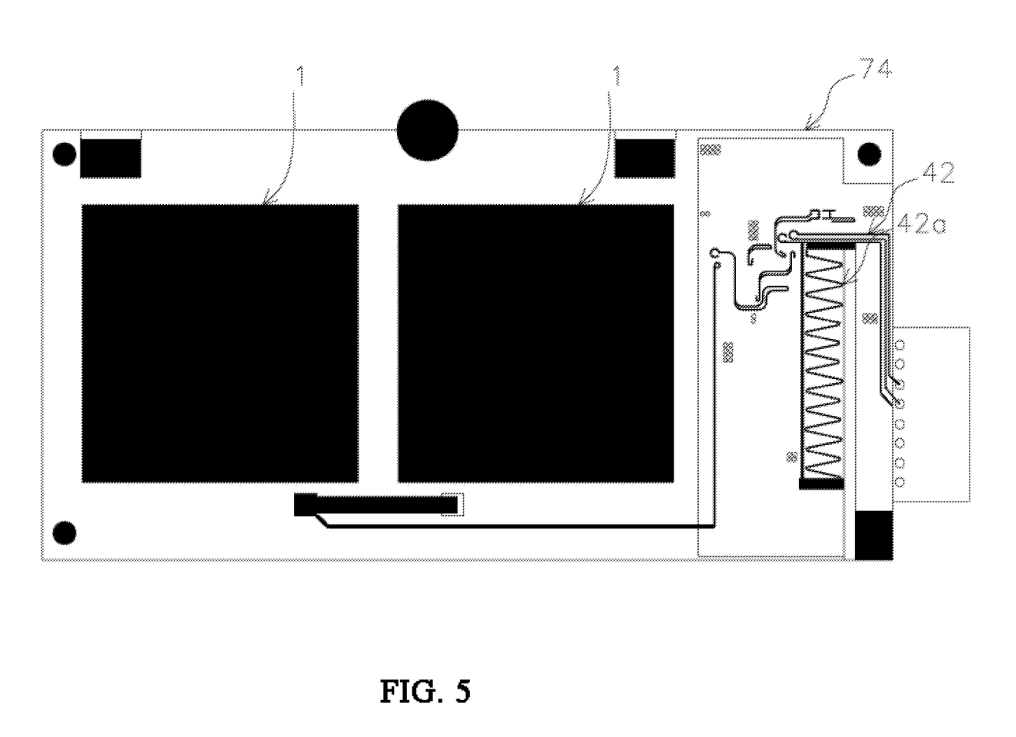

FIG. 2 is a perspective view of the micro fuel cell system according to an embodiment of the invention. FIG. 3 is a surface side view of the bipolar plate of the micro fuel cell system. Referring to FIG. 2 and FIG. 5, the micro fuel cell system further comprises a holder (7) for the arrangement of power-generating member (1), electrical transmission mechanism (2), fuel circulation module (3), sensor module (4), and computing module (5) therein. The holder (7) comprises a first portion (71) and a second portion (72). Power-generating member (1) is disposed in the first portion (71) of holder (7), while electrical transmission mechanism (2), fuel circulation module (3), sensor module (4), and computing module (5) are disposed in the second portion (72) of holder (7). The holder (7) has a board structure and is made of FR4, FR5, epoxy resin, fiberglass, ceramic, polymer, or composite board material.

The electrical transmission mechanism (2) comprises all kinds of electrical connections in the micro fuel cell system and at least an external connector (8). The external connector (8) has an electrical interconnect structure to provide electrical connection and mechanical engagement to the load (6) to achieve signal output or input between the computing module (5) and the load (6), and to transmit power generated by the power-generating member (1) to the load (6). The external connector (8) can further include a fuel inlet (81) and a fuel outlet (82) for the external communication of fuel flow channel (32), and an electric connector (83) to provide the electric transmission mechanism (2) with electric connection.

The fuel circulation module (3) has a fuel container (31) and a fuel flow channel (32). The fuel container (31) stores fuel needed for the operation of power-generating member (1) or residual solution from the power-generating member (1) after electrochemical reaction, and the fuel flow channel (32) transports fuel needed for the operation of power-generating member (1) or residual solution from the power-generation member (1) after electrochemical reaction. The fuel container (31) is disposed in an accommodation space in the second portion (72) of holder (7), while the fuel flow channel (32) is a fluid guide structure in the holder (7) and a part of which forms an anode flow channel (33) that corresponds to the anode of power-generating member (1). The fuel flow channel (32) also provides the anode fuel needed for the electrochemical reaction of power-generating member (1).

The sensor module (4) consists of a concentration meter (41), a level gauge (42), and a temperature sensor (43) for detecting respectively the fuel concentration, quantity, and temperature in the fuel cell.

The electrical transmission mechanism (2) has a voltage converter (21), which is a boost converter, a buck converter or a buck-boost DC/DC converter to convert the output power into specific voltage output. The voltage converter (21) is provided on the bipolar plate (74) of holder (7) using PCB technology.

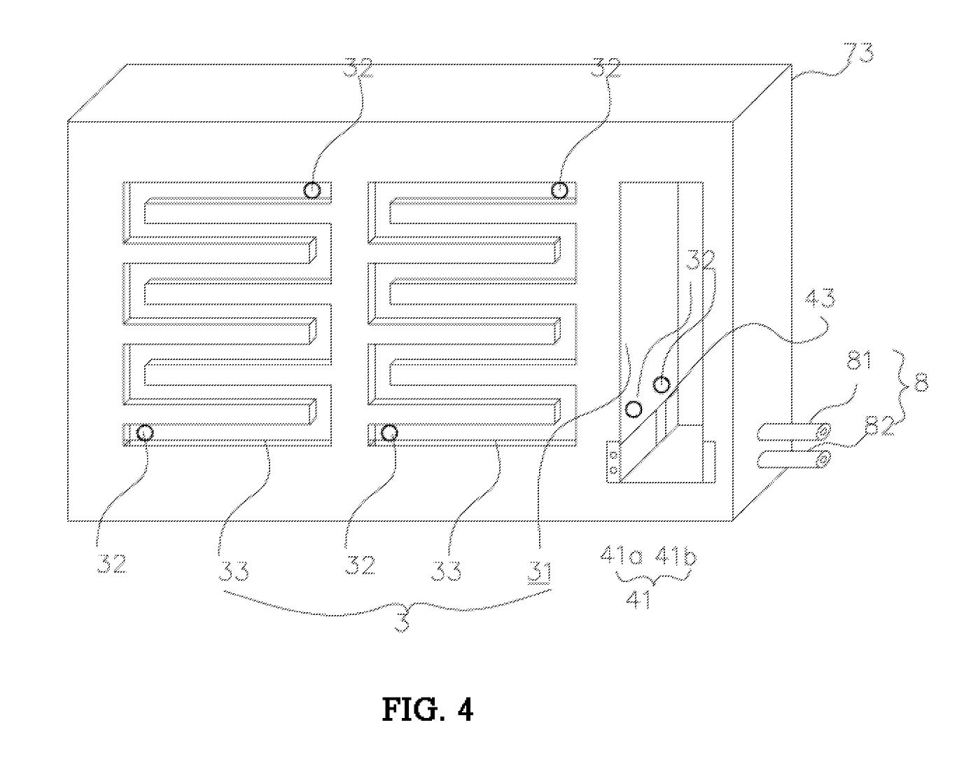

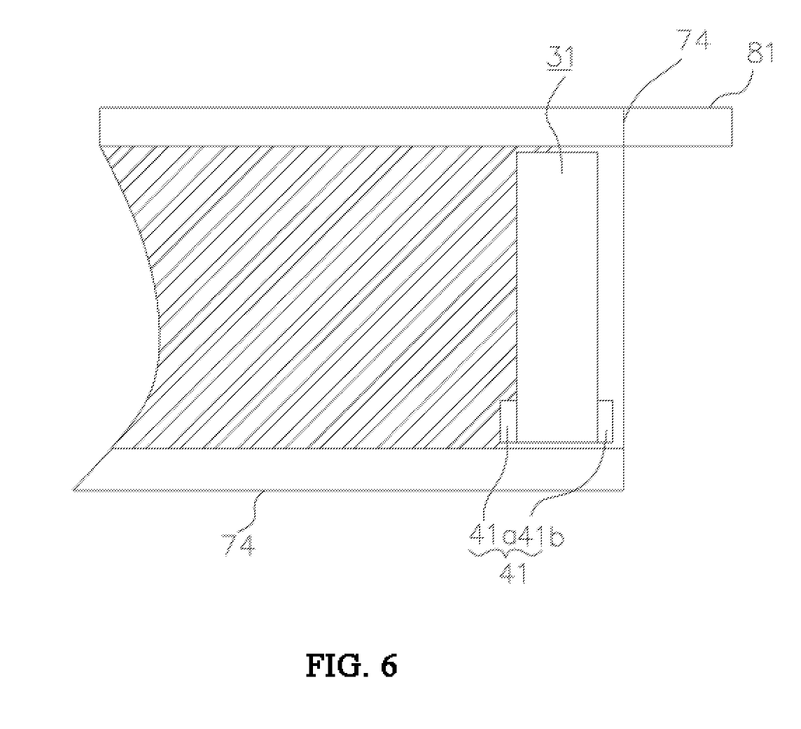

FIG. 4 is a perspective view of the flow-field plate of the micro fuel cell system. FIG. 6 is a side cut-away view of the micro fuel cell system. Referring to FIG. 4 and FIG. 6, the fuel container (31) can be formed by partially hollowing out the flow-field plate (73) of holder (7). Similarly, the fuel flow channel (32) and the anode flow channel (33) can be formed by partially hollowing out the flow-field plate (73) of holders (7) with the fuel container (31) communicating with the fuel flow channel (32) and the anode flow channel (33). The anode flow channel (33) corresponds to the anode of power-generating member (1) such that fuel in the fuel container (31) can be transported to the anode flow channel (33) through the fuel flow channel (32), and furthermore, supply the anode of power-generating member (1).

Moreover, concentration meter (41) in the sensor module (4) has a light-sensing element (41a) and a light source element (41b), wherein the light-sensing element (41a) contains at least a light sensor. The light-sensing element (41a) is a sensor that uses photosensitive element to convert light signal into electric signal, and the light sensor outputs a corresponding electric signal, commonly a current signal based on the dose of light radiation received. The light source element (41b) provides light source, which is infrared, visible light or single-wavelength light. The arrangement of light-sensing element (41a) and the light source element (41b) coordinates with the fuel container (31) of fuel circulation module (3) such that light emitted from the light source element (41b) can pass through the fuel in fuel container (31) and be received by the light sensing element (41a). When the light source element (41b) irradiates on the fuel in the fuel container (31), the fuel with different concentrations would possess different optical properties. As such, the electric signal output by the light sensor is related to the fuel concentration, and the computing module (5) stores such relational information. Thus when the concentration meter (41) of the sensor module (4) feeds back the electrical signal to the computing module (5), the computing module (5) can determine the corresponding fuel concentration based on such relational information and simultaneously execute a corresponding control procedure.

The arrangement of light-sensing element (41a) and the light source element (41b) could also coordinate with the fuel flow channel (32) (as shown in FIG. 2) in fuel circulation module (3) or any element in the fuel circulation module (3) such that light emitted from the light source element (41b) can pass through the fuel in fuel container (31) and be received by the light sensing element (4 la).

In addition, temperature sensor (43) can be disposed in the flow-field plate (73) of holder (7) and correspond to the fuel container (31) in fuel circulation module (3) to detect the fuel temperature.

FIG. 5 is another surface side view of the bipolar plate of the micro fuel cell system. Referring to FIG. 2 and FIG. 5, the level gauge (42) in the sensor module (4) has a capacitance sensor (42a) with specific capacitance characteristics, which outputs a corresponding capacitance signal based on the quantity of fuel in the fuel container (31) of fuel circulation module (3). Moreover, the arrangement of capacitance sensor (42a) coordinates with the fuel container (31) of fuel circulation module (3) such that after the quantity or height of fuel in the fuel container (31) changes, the capacitance sensor (42a) would have different capacitance values corresponding to different fuel quantities and the computing module (5) stores information on the relationship between the capacitance signal and capacitance value output by capacitance sensor (42a). Thus when the level gauge (42) of the sensor module (4) feeds back the electrical signal to the computing module (5), the computing module (5) can determine the corresponding fuel quantity based on such relational information, and simultaneously execute a corresponding control procedure.

The capacitance sensor (42a) can be replaced by a stripline. In such case, information on the physical property of fuel can be obtained by measuring the electrical signal of the stripline and the electrical signal measured may be the equivalent capacitance, equivalent inductance, or impedance of stripline, or a combination thereof. The computing module (5) further contains a microcontroller (5 1), which is a mountable logic operation and control program or a logic gate IC. Thus signals transmitted by the electrical transmission mechanism (2) can be read by the microcontroller (51). Those signals include feedback electrical signals from sensor module (4).

Referring to FIG. 2 and FIG. 6, the holder (7) of micro fuel cell system further comprises at least a flow-field plate (73) and at least a bipolar plate (74), which are respectively a plate structure, and the holder (7) is formed by the coupling of flow-field plate (73) and bipolar plate (74). Part of the fuel flow channel (32) is disposed in the flow-field plate (73). The part of bipolar plate (74) that corresponds to the first portion of holder (7) constitutes the power-generating member (1), and the fuel flow channel (32) in the flow-field plate (73) at least partially corresponds to the power-generating member (1) such that the fuel in fuel container (31) is transported to the power-generating member (1) via the fuel flow channel (32) in fuel-field plate (73), or residues in the power-generating member (1) after electrochemical reaction are transported out of power-generating member (1) via the fuel flow channel (32). Moreover, the flow-field plate (73) and the bipolar plate (74) are respectively made of FR4, FR5, epoxy resin, fiberglass, ceramic, polymer, or composite board material. The fuel flow channel (32) is a fluid guide structure formed by the body of flow-field plate (73).

The bipolar plate (74) can have a circuit board structure with the electrical transmission mechanism (2), sensor module (4) and computing module (5) disposed respectively thereon through PCB technology. Moreover, the fuel circulation module (3) can be arranged on the flow-field plate (73), and the fuel container (31) is a partially hollow fuel accommodation space formed by the body of flow-field plate (73).

In addition, the holder (7) can be constructed by attaching a bipolar plate (74) to each of the two side faces of a flow-field plate (73). A fuel flow channel (32) is formed on each of two side faces of the flow-field plate (73) to guide the fuel to power-generating member (1) on bipolar plate (74) where electrochemical reaction takes place and power is output, and to guide the reaction residues out of power-generating member (1).

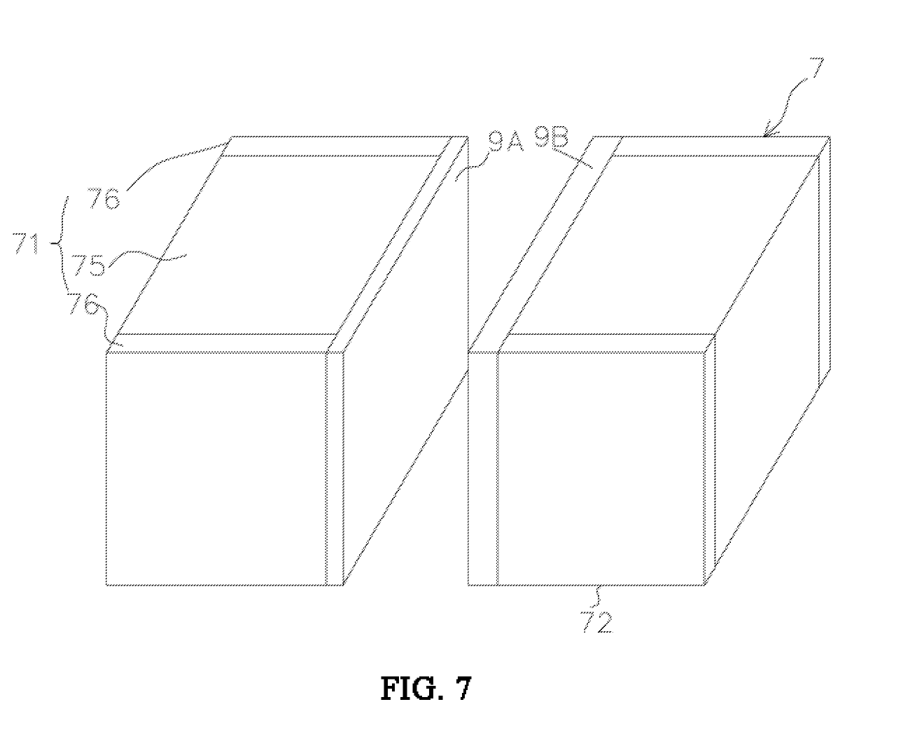

FIG. 7 is a side view of the micro fuel cell system according to another embodiment of the invention. As shown, the first portion (71) and the second portion (72) of the micro fuel cell system holder (7) are separate structures. The first portion (71) further contains at least a flow-field plate (75), at least a bipolar plate (76), and a first internal connector (9A). The second portion (72) further contains at least a second internal connector (9B). The flow-field plate (75) and the bipolar plate (76) are respectively a plate structure. The first internal connector (9A) and the second internal connector (9B) in second portion (72) are connector structures with electrical connection and mechanical engagement that can engage each other. The flow-field plate (75) and the bipolar plate (76) adjoin each other at side face. A part of fuel flow channel (32) is configured on the flow-field plate (75), while the other part of fuel flow channel (32) is disposed in the second portion (72). A portion of electrical transmission mechanism (2) is configured on the bipolar plate (76), while the other part of the electrical transmission mechanism (2) is disposed in the second portion (72). The sensor module (4) and the computing module (5) can be respectively disposed in the second portion (72) using PCB technology. The power-generating member (1) is disposed on the bipolar plate (76), and the part of fuel flow channel (32) on the flow-field plate (75) corresponds to the power-generating member (1) such that the fuel in fuel container (31) is transported to the power-generating member (1), or residues in the power-generating member (1) after electrochemical reaction are transported out of power-generating member (1) via the fuel flow channel (32).

The flow-field plate (75) in first portion (71), the bipolar plate (76) in first portion (72), and the second portion (72) are respectively made of FR4, FR5, epoxy resin, fiberglass, ceramic, polymer, or composite board material.

In addition, the first internal connector (9A) in the first portion (71) acts as the transmission interface between the fuel flow channel (32) in flow-field plate (75) of first portion (71) and the electrical transmission mechanism (2) in bipolar plate (76). The second internal connector (9B) in the second portion (72) acts as the transmission interface between the fuel flow channel (32) in second portion (72) and the electrical transmission mechanism (2). Thus through engagement between first internal connector (9A) and second internal connector (9B), the fuel flow channel (32) in the first portion (72) can communicate with the fuel flow channel (32) in the second portion (72), and the electrical transmission mechanism (2) in the first portion (71) is electrically connected to the electrical transmission mechanism (2) in the second portion (72).

Moreover, the fuel container (31) in fuel circulation module (3) is a partially hollow fuel accommodation space formed by the second portion (72).

The fuel flow channel (32) in the fuel circulation module (3) transports the fuel or the residual solution through the effect of gravity and siphonage.

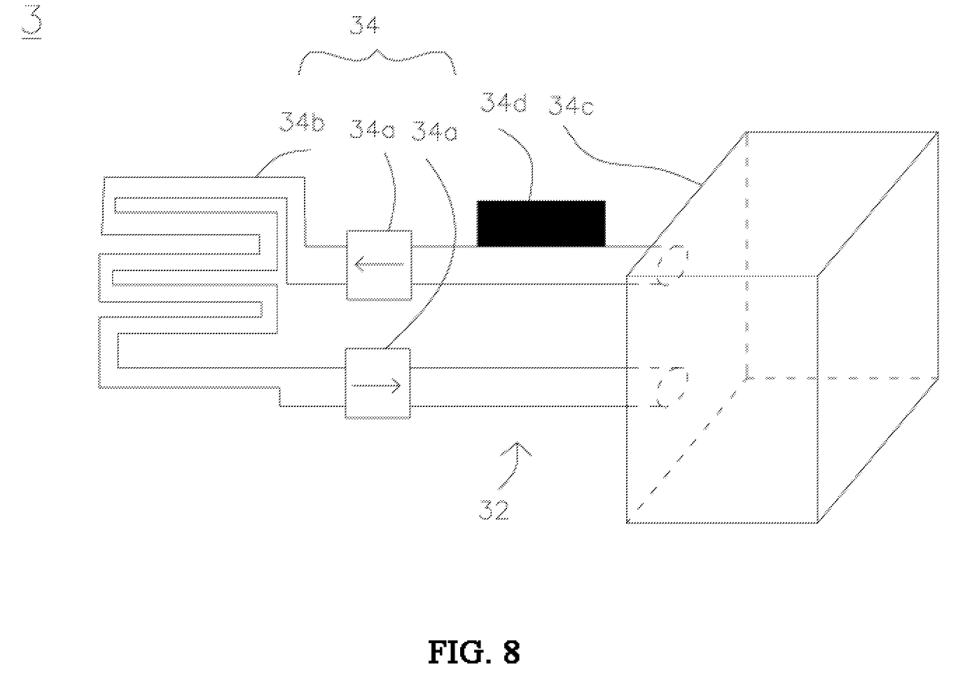

FIG. 8 a partial cut-away view of the fuel circulation module of the micro fuel cell system. As shown, the fuel circulation module (3) of the micro fuel cell system further contains a fluid actuator (34) to drive the circulation of fuel and residual solution in fuel flow channel (32). The fluid actuator (34) further contains at least a one-way valve (34a), a heating member (34b), and a cooling member (34c). The one-way valve (34a) is a component for confining the one-way flow of fluid; the heating member (34b) is an area in the fuel flow channel (32) formed in the vicinity of power-generating member (1), where fluid at the heating member (34b) is heated by the reaction heat generated during the electrochemical reaction of power-generating member (1); and the cooling member (34c) is an area of the fuel circulation module (3) near the fuel container (31), where fluid at the cooling member (34c) is cooled by the relatively low temperature in the surroundings. Thus when the power-generating member (1) of the micro fuel cell system undergoes electrochemical reaction, fuel in the fuel circulation module (3) would flow in the direction confined by the one-way valve (34a) to achieve the circulation of fuel and residual solution.

The fluid actuator (34) can further contain a heater (34d) composed of resistance heating wires and disposed in the fuel flow channel (32) to replace the action of heating member (34b).

In the embodiments described, when the power-generating member (1) of micro fuel cell system undergoes electrochemical reaction, the fuel in the fuel container (31) of fuel circulation module (3) is transported to the power-generating member (1) via the fuel flow channel (32), and residual solution formed in the power-generating member (1) after the electrochemical reaction is transported to the fuel container (31) also via the fuel flow channel (32). Moreover, when the power-generating member (1) of the micro fuel cell system undergoes electrochemical reaction and outputs power, it will transmit the power through the electrical transmission mechanism (2) to the external load (6), and when the power goes through the voltage converter (21) in the electrical transmission mechanism (2), power of specific voltage is output to accommodate the power needs of the load (6).

In the process of power-generating member (1) of the fuel cell system undergoing electrochemical reaction and outputting power, the concentration meter (41), level gauge (42) and temperature sensor (43) of the sensor module (4) would respectively detect the fuel concentration, quantity and temperature in the fuel cell, and feed back those physical properties in the form of electrical signals to the microcontroller (51) of the computing mudule (5). The microcontroller (51) would execute corresponding control procedures based on the electrical signal feedback.

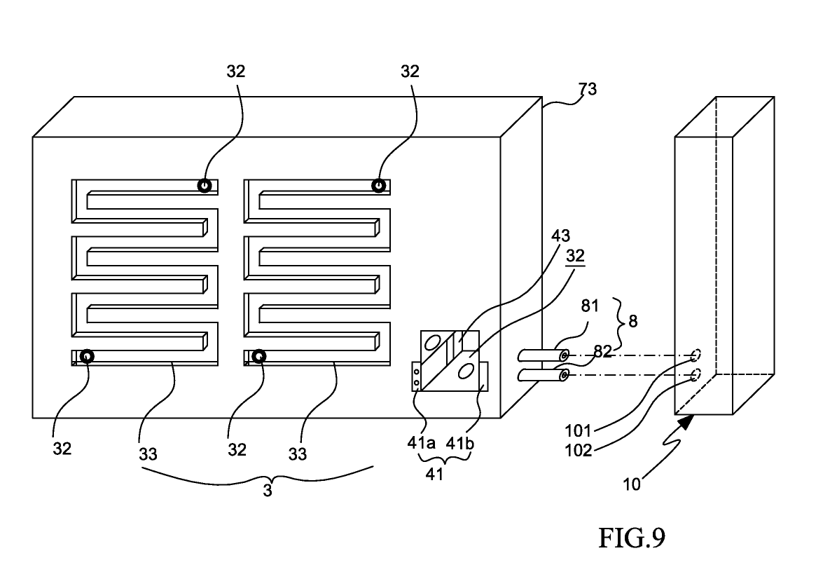

FIG. 9 is the perspective view of the flow-field plate of the micro fuel cell system according to yet another embodiment of the invention. As shown, the fuel circulation module (3) of micro fuel cell system is composed of the fuel flow channel (32) and the anode flow channel (33), and the concentration meter (41) and temperature sensor (43) are disposed in a part of the fuel flow channel (32), wherein the light-sensing element (41a) and light source element (41b) are disposed on two sides of the corresponding part of fuel flow channel (32). The micro fuel cell system further contains a fuel cartridge (10) having a hollow structure for storing the fuel. The fuel cartridge (10) has a fuel outlet (101) and a fuel inlet (102) that correspond respectively to the fuel inlet (81) and fuel outlet (82) of flow-field plate (73) such that the fuel outlet (101) and fuel inlet (102) mechanically engage and communicate with the corresponding fuel inlet (81) and fuel outlet (82). Thus fuel in the fuel cartridge (10) can flow through fuel outlet (101) and fuel inlet (81) into the fuel flow channel (32) of flow-field plate (73), and then through the anode flow channel (33) to supply the power-generating member (1), while the residual fuel in the power-generating member (1) can pass through fuel outlet (82) and fuel inlet (102) to return to the fuel cartridge (10).

The preferred embodiments of the present invention have been disclosed in the examples. However the examples should not be construed as a limitation on the actual applicable scope of the invention, and as such, all modifications and alterations without departing from the spirits of the invention and appended claims shall remain within the protected scope and claims of the invention.

What is claimed is:

1. A micro fuel cell system, comprising:
a fuel cell power-generating member for electrochemical reaction with the fuel and power output;
an electrical transmission mechanism for the transmission of electrical signals and power in the micro fuel cell system;
a fuel circulation module containing a fuel flow channel for transporting fuel in the micro fuel cell system;
a concentration meter consisting of a light-sensing element and a light source element, the light-sensing element and the light source element being disposed at two opposing sides of a part of fuel flow channel for detecting the physical property of fuel concentration and outputting an electrical signal corresponding to said physical property;
a computing module that selects and executes the corresponding control procedure based on the electrical signal of said physical property; and
a holder;
wherein the fuel cell power-generating member, the electrical transmission mechanism, the fuel circulation module, the concentration meter, and the computing module are arranged in the holder.

2. The micro fuel cell system according to claim 1, wherein the holder has a board structure.

3. The micro fuel cell system according to claim 2, wherein the board structure of holder includes:
at least a flow-field plate having a plate structure with fuel circulation module arranged thereon; and at least a bipolar plate having a circuit board structure with fuel cell power-generating member, electrical transmission mechanism, concentrate meter and computing module arranged thereon;
wherein the fuel flow channel is at least partially disposed in the flow-field plate, and the fuel flow channel in the flow-field plate at least partially corresponds to the fuel cell power-generating member where fuel is transported to the fuel cell power-generating member and residual fuel is transported out of fuel cell power-generating member via the fuel flow channel.

4. The micro fuel cell system according to claim 3, wherein the fuel flow channel is a fluid guide structure formed by the body of flow-field plate.

5. The micro fuel cell system according to claim 4, wherein the fuel flow channel is formed by partially hollowing out the flow-field plate.

6. The micro fuel cell system according to claim 4, wherein the fuel circulation module further consists of a fuel container, the fuel container being a partially hollow fuel accommodation space formed by the body of flow-field plate and communicating with the fuel flow channel.

7. The micro fuel cell system according to claim 6, further comprising a level gauge, the level gauge being arranged to correspond to the fuel container and outputting a corresponding electrical signal based on the quantity of fuel in the fuel container of fuel circulation module.

8. The micro fuel cell system according to claim 7, wherein the level gauge contains a capacitance sensor, the capacitance sensor being disposed on the bipolar plate corresponding to the fuel container and having specific capacitance characteristics, and able to output a corresponding capacitance signal based on the quantity of fuel in the fuel container.

9. The micro fuel cell system according to claim 8, wherein the capacitance sensor is a stripline capacitor.

10. The micro fuel cell system according to claim 8, wherein the capacitance sensor is a stripline capacitor, and any electrical signal of the equivalent capacitance, equivalent inductance, or impedance of stripline, or combination thereof corresponds to the fuel level.

11. The micro fuel cell system according to claim 3, wherein the flow-field plate further contains a fuel inlet and a fuel outlet, the fuel inlet and the fuel outlet being disposed on the flow-field plate and communicating with the fuel circulation module.

12. The micro fuel cell system according to claim 11, further comprising a fuel cartridge, the fuel cartridge being a hollow structure for storing fuel and having a fuel outlet and a fuel inlet, said fuel outlet and said fuel inlet respectively corresponding to the fuel inlet and fuel outlet on the flow-field plate, and mechanically engaging and communicating with the corresponding fuel inlet and fuel outlet.

13. The micro fuel cell system according to claim 3, wherein the holder is constructed by attaching a bipolar plate to each of the two side faces of a flow-field plate, each of two side faces of the flow-field plate having a fuel flow channel being formed thereon to guide the fuel to the fuel cell power-generating member on bipolar plate and to guide the residual fuel out of the fuel cell power-generating member.

14. The micro fuel cell system according to claim 3, wherein the holder is made of FR4, FR5, epoxy resin, fiberglass, ceramic, polymer or composite board material.

15. The micro fuel cell system according to claim 3, wherein the electrical transmission mechanism contains an electrical connector, the electrical connector being an electrical interconnect structure disposed in the bipolar plate to provide electrical connection and mechanical engagement.

16. The micro fuel cell system according to claim 3, wherein the electrical transmission mechanism contains a fuel inlet and a fuel outlet, the fuel inlet and the fuel outlet being disposed on the flow-field plate and communicating respectively with the fuel flow channel and providing the fuel flow channel with external communication.

17. The micro fuel cell system according to claim 3, further comprising a temperature sensor for detecting the temperature of fuel in the fuel cell.

18. The micro fuel cell system according to claim 17, wherein the temperature sensor is disposed on the bipolar plate and corresponds to the fuel flow channel.

19. The micro fuel cell system according to claim 17, wherein the temperature sensor is disposed on the bipolar plate and corresponds to the fuel container.

20. The micro fuel cell system according to claim 1, wherein the light source is infrared, visible light or single-wavelength light.

21. The micro fuel cell system according to claim 1, wherein the holder contains a first portion and a second portion, the fuel cell power-generating member, a part of electrical transmission mechanism, and a part of fuel circulation module are arranged in the first portion of holder, and another part of electrical transmission mechanism, another part of fuel circulation module, the concentration meter and the computing module are arranged in the second portion of holder.

22. The micro fuel cell system according to claim 21, wherein the first portion of holder is a board structure, and the second portion of holder is another board structure, the first portion containing a first internal connector, the second portion containing a second internal connector, the first internal connector and the second portion of the second internal connector comprising a structure with electrical connection and mechanical engagement and a structure communicating with the fuel circulation module that corresponds to the first portion and the second portion of holder.

23. The micro fuel cell system according to 22, wherein the first internal connector in the first portion acts as a transmission interface between the fuel flow channel in flow-field plate of first portion and the electrical transmission mechanism in bipolar plate.

24. The micro fuel cell system according to claim 22, wherein the fuel container in fuel circulation module is a partially hollow fuel accommodation space formed by the second portion, and the second internal connector in the second portion acts as the transmission interface between the fuel flow channel in second portion and the electrical transmission mechanism.

25. The micro fuel cell system according to claim 22, wherein the first portion of holder further contains at least a flow-field plate and at least a bipolar plate, the flow-field plate and the bipolar plate being respectively a plate structure.

26. The micro fuel cell system according to claim 25, wherein the fuel circulation module further comprises an anode flow channel which communicates with the fuel flow channel, the anode flow channel being disposed in the flow-field plate in the first portion of holder and corresponding to the fuel cell power-generating member, the fuel cell power-generating member being disposed in the bipolar plate in the first portion of holder.

27. The micro fuel cell system according to claim 26, wherein the flow-field plate in the first portion of holder is made of FR4, FR5, epoxy resin, fiberglass, ceramic, polymer or composite board material.

28. The micro fuel cell system according to claim 26, wherein the bipolar plate in the first portion of holder is made of FR4, FR5, epoxy resin, fiberglass, ceramic, polymer or composite board material.

29. The micro fuel cell system according to claim 26, wherein the fuel flow channel and the anode flow channel are fluid guide structures formed by the body of flow-field plate in the first portion of holder.

30. The micro fuel cell system according to claim 22, wherein the second portion of holder further contains at least a flow-field plate and at least a circuit board, the flow-filed plate and the circuit board having respectively a board structure.

31. The micro fuel cell system according to claim 30, wherein the part of fuel circulation module in the second portion of holder is electrically disposed on the flow-field plate in the second portion of holder, and the part of electrical transmission mechanism, the concentration meter and the computing module arranged in the second portion of holder are electrically disposed on the circuit board in the second portion of holder.

32. The micro fuel cell system according to claim 31, wherein the fuel circulation module further comprises a fuel container, the fuel container being a partially hollow fuel accommodation space formed by the body of flow-field plate in the second portion of holder and communicating with the fuel flow channel.

33. The micro fuel cell system according to claim 32, further comprising a level gauge, the level gauge being arranged to correspond to the fuel container and outputting a corresponding electrical signal based on the quantity of fuel in the fuel container of fuel circulation module.

34. The micro fuel cell system according to claim 33, wherein the level gauge contains a capacitance sensor, the capacitance sensor being disposed on the circuit board in the second portion of holder corresponding to the fuel container and having specific capacitance characteristics, and able to output a corresponding capacitance signal based on the quantity of fuel in the fuel container.

35. The micro fuel cell system according to claim 34, wherein the capacitance sensor is a stripline capacitor.

36. The micro fuel cell system according to claim 35, wherein the capacitance sensor is a stripline capacitor, and any electrical signal of the equivalent capacitance, equivalent inductance, or impedance of stripline, or the combination thereof corresponds to the fuel level.

37. The micro fuel cell system according to claim 1, wherein the fuel circulation module further comprises a fluid actuator to drive the circulation of fluid and residual solution in the fuel flow channel.

38. The micro fuel cell system according to claim 37, wherein the fluid actuator further comprises at least a one-way valve, a heating member and a cooling member;
the one-way valve being a component for confining the one-way flow of fluid;
the heating member being an area in the fuel flow channel formed in the vicinity of fuel cell power-generating member, where fluid at the heating member being heated by the reaction heat generated during the electrochemical reaction of the power-generating member; and
the cooling member being an area of the fuel circulation module near the fuel container, where fluid at the cooling member being cooled by the relatively low temperature in the surroundings.

39. The micro fuel cell system according to claim 37, wherein the fluid actuator further comprises at least a one-way valve, a heater and a cooling member;
the one-way valve being a component for confining the one-way flow of fluid;
the heater being disposed in the fuel circulation module for heating the fuel; and
the cooling member being an area of the fuel circulation module near the fuel container, where fluid at the cooling member being cooled by the relatively low temperature in the surroundings.

40. The micro fuel cell system according to claim 39, wherein the heater is composed of a resistance heating wire.

41. The micro fuel cell system according to claim 1, wherein the electrical transmission mechanism includes a voltage conversion means, the voltage conversion means converting the output power into a specific voltage output.

42. The micro fuel cell system according to claim 41, wherein the voltage conversion means is a boost converter, a buck converter or a buck-boost converter.

43. The micro fuel cell system according to claim 1, wherein the computing module further contains a microcontroller, the microcontroller being a mountable logic operation and control program.

44. The micro fuel cell system according to claim 1, wherein the computing module further contains a microcontroller, the microcontroller being any logic gate IC.
